(19) United States
(12) Patent Application Publication
(10) Pub. No.: US 2004/0116239 A1
(43) Pub. Date: Jun. 17, 2004

(54) Continuously variable friction gear

(76) Inventor: Jurgen Wafzig, Eriskirch (DE)

Correspondence Address: DAVIS & BUJOLD, P.L.L.C., FOURTH FLOOR, 500 N. COMMERCIAL STREET, MANCHESTER, NH, 03101-1151, US

(21) Appl. No.: 10/476,473

(22) PCT Filed: Apr. 27, 2002
(86) PCT No.: PCT/EP02/04689

(30) Foreign Application Priority Data
May 3, 2001 (DE) 101 21 487.1

(51) Int. Cl. F16H 15/38

(52) U.S. Cl. 476/40

(57) ABSTRACT

A continuously variable friction gear with two gear units is so designed that the two supports of each gear unit are connected to one another in each case by endless chains extending at an angle to the longitudinal axis of the continuously variable friction gear, in such manner that one chain loops round the first (front) support of the first gear unit and the second (rear) support of the second gear unit, and the other chain loops round the second (front) support of the first gear unit and the first (rear) support of the second gear unit, and each endless chain is associated with a control device which is arranged between the two chain strands of an endless chain and acts upon their inner sides with an adjustable force. Accordingly, the angular and transmission ratio adjustment takes place directly, without axial displacement.

The present invention concerns a continuously variable friction gear according to the preamble of claim 1.

A continuously variable friction gear of this type usually comprises input and output disks arranged coaxially on a common shaft. The disks are arranged in pairs with one another having inner surfaces that are designed with a toroidal shape, with friction wheels arranged between the pairs of input and output disks. These friction disks are in frictional contact with both the input disks and the output disks, and transfer the torque transferred to them by the input disks to the output disks by frictional contact, the rotation speed of the friction wheels being higher, the greater the distance between their contact point with the input disks and the rotation axis is. In contrast, the rotation speed of the output disks is the higher, the closer their point of contact with the friction wheel to the rotation axis is. By swivelling the friction wheels, the rotation speed of the output disks can accordingly be adjusted infinitely variably and in any desired way. For this purpose the rotation axles of the friction wheels are in each case mounted on a support which can be controlled by a swivelling device.

Such a continuously variable friction gear is described in detail in DE 197 54 725 by the present applicant. This gear system contains two gear units arranged coaxially on the input shaft, each gear unit comprising an input and an output disk between which two friction wheels are respectively arranged, each friction wheel being fixed on a swivelling support. Both the input and output disks are mounted on a torque shaft, which can be displaced slightly in the axial direction relative to the input shaft. The input disk of one gear unit is attached rotationally fast to the torque shaft, but mounted on it so that it can slide. The input disk of the other gear unit is also connected rotationally fast relative to the torque shaft by means of gear teeth. The two output disks of the two gear units are arranged mirror-symmetrically to one another and next to one another in the gear system and on a common bush, so that the torques transferred from one input disk to its associated output disk from the other input disk to its associated output disk, are transferred by the two output disks, both connected rotationally fast with the bush, to a gearwheel which meshes with a gearwheel of an output shaft. A roller-shaped pressure device acts on one of the input disks, which is mounted on the input shaft and can be axially displaced on it and is in rotationally fast connection with it.

In this known continuously variable friction gear the transmission ratio is usually adjusted by displacing the friction wheels tangentially to the transmission axis, during which, however, swivelling forces act from the input and output shafts on the friction wheel positioned between them, since to transfer the torque the latter have to be pressed against the friction wheel. In conventional continuously variable gear systems the friction wheel in each gear unit is arranged in such manner that its swivel axis is located at the mid-point of the torus formed by the associated input and output disks. At the contact points between the friction wheel and the associated input and output disks, so-termed normal forces are therefore produced during the adjustment of the transmission ratio.

To prevent the possibility that if the normal forces occurring during the transmission ratio adjustment are unequal, the torque on the friction wheel caused by this might bring about an undesired transmission ratio change, in DE 198 26 057 by the present inventor, it has already been proposed to compensate any difference of the normal forces by producing a control force, such that when the friction wheel is axially fixed this control force, which leads to tilting of the friction wheel, can be applied to one of the two associated disks, while when one of the disks is axially fixed the control force acts on the friction wheel.

It has also already been proposed to support the friction wheels in a continuously variable friction gear by means of two connecting rods, which counteract the reaction forces occurring. For this, the swivelling movement of the friction wheels is made possible by roller bearings; this design, however, has the disadvantage that the weight of the friction gear is large and there is no coupling of the swivel movements of the two friction wheel supports arranged in one gear unit.

In these known friction gear systems the friction wheel supports have to be continuously braced by high hydraulic pressures during operation. This both has a negative effect on the efficiency of the friction gear since a larger hydraulic pump with higher power uptake is needed, and entails measures to ensure additional synchronization between the individual supports, because the purely hydraulic coupling can be affected by oscillations.

The purpose of the present invention is to replace the hydraulic pressure and adjustment device by direct control of the swivel angle of the supports, without this resulting in lower efficiency due to increased transverse drag caused by differing tolerances and load distributions.

These objectives are achieved by the features indicated in the characterizing portion of claim 1; advantageous embodiments are described in the subordinate claims.

According to the invention, it is thus proposed that the two supports of each gear unit are connected to one another by means of two endless chains extending each at an angle to the longitudinal axis of the friction gear, in such manner that one chain is looped around the first (front) support of the first gear unit and the second (rear) support of the second gear unit, while the other chain is looped around the second (front) support of the first gear unit and the first (rear) support of the second gear unit, so that the two endless chains cross between the four supports but do not contact one another, and each endless chain is associated with a control device arranged between the two chain strands of a respective chain and acts upon their two inner sides with an adjustable force.

The control devices for the two endless chains are designed as chain tensioners mounted so that they can swivel, with the pivot of the chain tensioner arranged symmetrically relative to the two chain strands; when the chain tensioner is swivelled by means of an adjustable force that can be applied by hydraulic or mechanical means, the two chain strands are spread apart so that the tension of the chain increases.

In a variant of this invention the control devices can be arranged outside the chains and will then modify the chain tension from the outside.

The controlled chain tensioning or relaxation by means of the control devices according to the invention for the two chain strands of each endless chain provides the desired variability of adjustment and synchronization. Since adjustment of the transmission ratio can be achieved without axial displacement, the structure of the variator can be considerably simplified. The crossbars no longer need to be able to move so as to effect the tilting movement. It is only necessary for the supports to be able to rotate, without any axial displacement. Thus, the frame brackets can also be partially omitted and the crossbars integrated as fixed components in the frame of the continuously variable friction gear.

Below, the invention is explained in more detail with reference to the drawing, in which an advantageous example embodiment is illustrated and which shows:

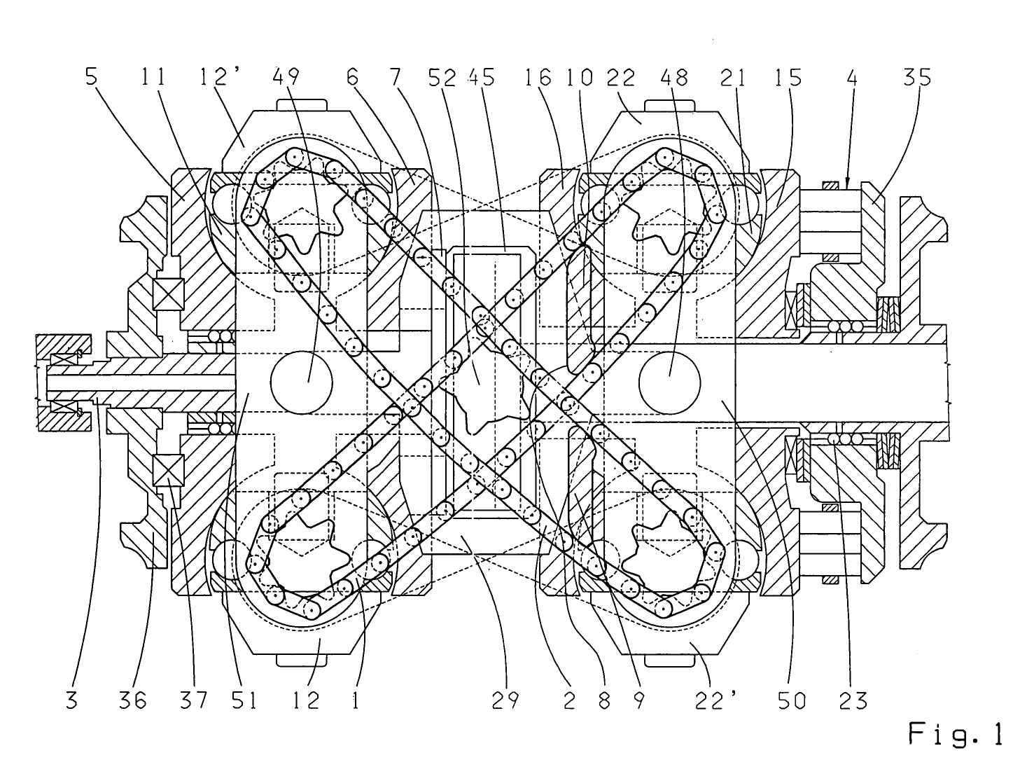

FIG. 1 is a schematic view of a continuously variable friction gear showing the arrangement of the endless chains; and

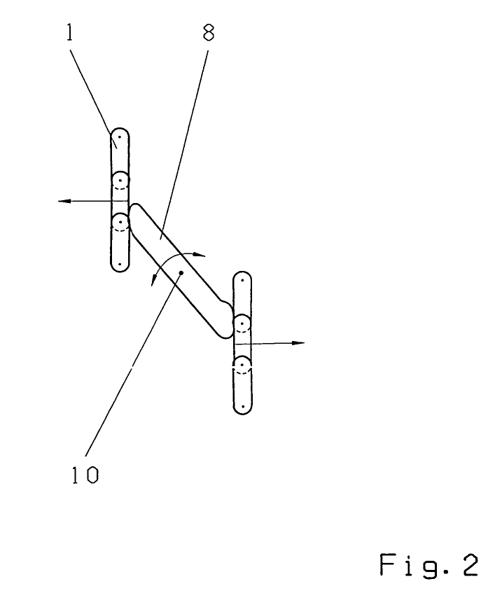

FIG. 2 is an example embodiment of a control device for an endless chain.

The continuously variable friction gear illustrated schematically in FIG. 1 with two gear units corresponds in its structure to that described as an example in DE 197 36 830 by the present applicant. The input shaft 3 of the friction gear is connected to a starting element (not shown), for example a torque converter or a wet-operating getaway clutch of a drive motor of a motor vehicle. Coaxially with the input shaft 3 are arranged two gear units, one of the said gear units having an input disk 5 and an output disk 6 whose surfaces facing one another are designed in a toroid shape. The other gear unit has an input disk 15 and an output disk 16 arranged opposite it, whose surfaces facing one another are also designed in a toroid shape. In the two gear units respectively, two friction wheels 11, 21 are provided, which are attached to swivelling supports 12 and 22 such that they can swivel relative to the longitudinal axis of the input shaft 3. The respective friction wheels 11, 21 are in friction-force contact with the two inwards-facing surfaces of the input disks 5, 15 and the output disks 6, 16, with the friction wheels of a gear unit arranged symmetrically relative to the axis of the input shaft 3.

The usual roller-shaped pressure device is indexed is indexed as 4, a bearing support element 7, a bearing 23, a frame bracket 29, a disk with a curved track 35, an axial disk 36, a bearing 37, a cut-out 45, two pins 48 and 49, and two crossbars 50 and 51.

If the friction wheels 11, 21 are now inclined relative to the longitudinal axis of the input shaft, the points of contact of the circumference of the friction wheels 11, 21 is displaced along the toroidal surfaces of both the input and the output disks, as a result of which the transmission ratio between an input and an output disk can be adjusted continuously, i.e. with infinite variability.

Now, to be able to control the swivelling angle of the supports directly without the coupling of the supports to one another causing stresses due to different tolerances and load distributions, with increased transverse drag and consequent low efficiency, according to the invention two endless chains 1, 2 are provided, respectively extending diagonally from the left front support 12 to the right rear support 22 and from the right front support 22′ to the left rear support 12′ as shown in FIG. 1, in such manner that each chain loops around the two supports of the two different gear units associated respectively with it, so that the pair of chains cross but without touching one another. The two chains 1, 2 are synchronized with one another by the transmission ratio control unit 52. This comprises essentially an axle with two toothed wheels in two different planes. The variability of the adjustment and synchronization is achieved by virtue of controlled chain tensioning or relaxation, and this is done by means of a control device 52 provided according to the invention, which influences the two chain strands of each endless chain at the same time. The transmission ratio control device 52 engages in one of the endless chains in each case and, by virtue of the supports 12, 22, influences the variator transmission ratio. In the figure the chains are shown in a not fully tensioned condition to make the representation more easily understandable; however, according to the invention the toothed wheels shown are engaged in the chain links.

These two control devices for the two endless chains 1, 2 have index number of 8 and 9 in FIG. 1, and are arranged between the parallel strands of the respective endless chains in such manner that their ends are in contact with the inner sides of the chain strands. Each chain tensioner is mounted symmetrically relative to the two chain strands with a pivot through its middle on which it can swivel, and is acted upon with a predetermined force by mechanical or hydraulic means so that as a function of the swivelling of the control device, the corresponding endless chain is tensioned to a greater or lesser extent and the rotation play between the supports can be adjusted. In this, said adjustment takes place without any axial displacement, which contributes towards simplifying the structure of the continuously variable friction gear.

FIG. 2 shows an example embodiment of a control device 8, advantageously consisting of a swivelling lever mounted on a pivot 10, one end of the lever facing towards one chain strand of the endless chain 1 while its other end is associated with the second strand of the endless chain 1, so that the ends of the swivelling lever contact the inner sides of the chain strands. In this way the two chain strands are tensioned to a greater or lesser extent simultaneously.

Reference Numerals

1 Endless chain 21 Friction wheel

2 Endless chain 22 Support

3 Input shaft 23 Bearing

4 Pressure device 29 Frame bracket

5 Input disk 35 Curved-track disk

6 Output disk 36 Axial disk

7 Bearing support element 37 Bearing

8 Control device 45 Cut-out

9 Control device 48 Pin

10 Pivot 49 Pin

11 Friction wheel 50 Crossbar

12 Support 51 Crossbar

15 Input disk 52 Transmission ratio control device

16 Output disk

1. Continuously variable friction gear with:
an input shaft,
two input disks (5, 15) arranged coaxially with the input shaft, having toroid-shaped inner surfaces,
two output disks (6, 16) arranged coaxially with the input shaft, having toroid-shaped inner surfaces, such that in each case one input disk and one output disk form a pair and the two output disks are arranged mirror-symmetrically to one another and next to one another,
several friction wheels (11, 21) arranged between the inner surfaces of the input/output disk pairs and able to tilt between them in order to transfer a torque from the input disk to the associated output disk,
a support (12, 22) for each friction wheel (11, 21),
a pressure device (4) for pushing the input disks towards the output disks in order to produce the torque-dependent axial force, and
a swivelling device for the friction wheel supports,
characterized in that the supports of the two gear units are connected to one another by two endless chains (1, 2) extending each at an angle to the longitudinal axis of the continuously variable friction gear, in such manner that a chain (1) loops round the first (front) support (12) of the first gear unit and the second (rear) support (22) of the second gear unit, and the other chain (2) loops round the second (front) support (12′) of the first gear unit and the first (rear) support (22′) of the second gear unit (as shown in FIG. 1), so that the two endless chains (1, 2) cross between the supports but do not touch one another, and each endless chain (1, 2) is associated with a control device (8, 9) which is arranged between the two chain strands of the respective endless chains (1, 2) and acts upon their inner sides with an adjustable force, a transmission ratio control device (52) also being provided, which engages respectively in each of the endless chains and influences the variator transmission ratio by virtue of the supports (12, 22).

2. Continuously variable friction gear according to claim 1, characterized in that the control device (8, 9) consists of a swivelling lever mounted to swivel on a pivot (10) which passes through the middle of the swivelling lever, such that the two ends of the swivelling lever contact the inner sides of the two strands of an endless chain (1, 2) in each case with a predetermined force.

3. Continuously variable friction gear according to claims 1 or 2, characterized in that the swivelling lever (8, 9) can be swivelled by hydraulic means.

4. Continuously variable friction gear according to claims 1 or 2, characterized in that the swivelling lever (8, 9) can be swivelled by mechanical means.

5. Continuously variable friction gear according to claims 1 or 2, characterized in that the swivelling lever (8, 9) can be adjusted by electrical means.

6. Continuously variable friction gear according to claims 1 or 2, characterized in that the swivelling lever (8, 9) can be adjusted by pneumatic means.

7. Continuously variable friction gear according to any of the preceding claims, characterized in that the control device (8, 9) is arranged outside the chains (1, 2).
